(19) United States
(12) Patent Application Publication
(10) Pub. No.: US 2012/0093349 A1
(43) Pub. Date: Apr. 19, 2012

(54) HEARING AID WITH BATTERY DOOR LOCKING MECHANISM AND METHOD FOR OPERATING THE BATTERY DOOR LOCKING MECHANISM

(75) Inventors: Li Nah Chua, Singapore (SG); Harald Klemenz, Fuerth (DE); Pei Chyi Kristy Lim, Fuerth (DE); Boon Lan Ng, Singapore (SG); Yong Kiat Ng, Singapore (SG)

(73) Assignee: SIEMENS MEDICAL INSTRUMENTS PTE. LTD., Singapore (SG)

(21) Appl. No.: 13/262,695

(22) PCT Filed: Apr. 3, 2009
(86) PCT No.: PCT/SG2009/000125

§ 371 Date: Dec. 23, 2011

(51) Int. Cl. H04R 25/00; E05C 19/16

(52) U.S. Cl. 381/323; 292/251.5

(57) ABSTRACT

A hearing aid includes a housing, a battery door configured to receive a battery, and a battery door locking mechanism. The battery door locking mechanism includes a magnetic element configured to magnetically lock or unlock the battery door. In order to open the battery door, an external actuator having a magnetic device is brought close to the hearing aid and the battery door locking mechanism of the hearing aid is actuated magnetically. A method for operating the battery door locking mechanism is also provided.

Various embodiments relate generally to a hearing aid with a battery door locking algorithm. Furthermore, various embodiments relate to a method for operating the battery door locking mechanism of a hearing aid.

In consideration of the fact that the average age of the population in almost all of the industrialized and emerging countries increases, a growth of the need of compensation of symptoms of old age is expected. In this context, also the decrease of the capability of hearing of aging people becomes a more and more important issue. For the compensation of this deficiency, electrical hearing aids (also known as hearing instruments) are used in an increasing number.

A hearing aid is an electro-acoustic body-worn apparatus which typically fits in the wearer's ear or behind the wearer's ear. The hearing aid is usually configured to amplify and modulate sounds for the wearer and usually includes a housing, a microphone, a loudspeaker, a battery, and electronic circuitry.

There are various types of hearing aids, which may vary in shape, size and application. Some exemplary types of hearing aids are BTE (Behind The Ear) hearing aids, ITE (In The Ear) hearing aids, OTE (Over The Ear) hearing aids, ITC (In The Canal) hearing aids, MIC (Mini Canal) hearing aids, CIC (Completely in the Canal) hearing aids, RITE (Receiver in The Ear) hearing aids, and eyeglass hearing aids, for example.

Since a hearing aid is a portable device equipped with components that need electrical energy for their operation a hearing aid usually includes a battery for supplying the various electrical components with electrical energy. Such a battery will be discharged after a certain time of operation or storage. In this case, the battery has to be replaced by a new one before the operation of the hearing aid can be continued. Alternatively, if the battery is rechargeable (accumulator), it can be recharged without a replacement. However, even when a rechargeable battery is used, it might have to be replaced some day when the limit of the number of recharge cycles is achieved.

To enable the replacement of a discharged battery a hearing aid is normally equipped with a battery door configured to release the discharged battery and to receive a new battery. In a conventional hearing aid, the battery door is opened manually, e.g. using a nail grip.

In addition, some conventional hearing aids provide a battery door locking mechanism to lock the battery door in order to prevent its undesired opening. The locking mechanism is intended to avoid damaging of the battery door or unintended loss of the battery. In particular, the locking mechanism shall protect children from swallowing the battery. For that reason the locking mechanism may also be referred to as a child safety lock.

The operation of the most common battery door locking mechanisms for hearing aids is described in the following.

Some hearing aids include a lock which is accessible via a small hole in their housing. The lock may include a recess for moving the lock along its axis by a pointed tool, e.g. a small screwdriver. Depending on the position of the lock, the battery door is locked or unlocked wherein the respective locking state is visually indicated by the position of the recess.

Alternatively, some conventional hearing aids include a slotted-head bolt which is accessible via a small hole in the housing of the respective hearing aid. The slotted-head bolt can be turned by a small screwdriver. Depending on the position of the bolt, the battery door is locked or unlocked, wherein the respective locking state is visually indicated by the orientation of the slot in the bolt's head.

Other conventional hearing aids include a battery door locking mechanism which is disposed in the battery compartment and attached to the battery door. To access this kind of mechanism the battery door is opened until there is a small gap between the battery door and the housing of the hearing aid. At this point in time the battery door is still locked so that it is impossible to open it completely. Then, the battery door is unlocked by inserting a pointed tool, e.g. a small screwdriver, through the gap into the battery compartment and pressing the tool into a recess of the locking mechanism. Afterwards, the battery door can be completely opened. This kind of mechanism locks the battery door automatically every time the battery door is closed, wherein no tool is needed for locking the battery door.

A similar hearing aid includes a battery door locking mechanism which is also disposed in the battery compartment and attached to the battery door. Instead of the above described recess, the locking mechanism includes a small button which is disposed at one of its long sides. To access the button, the battery door is opened until there is a small gap between the battery door and the housing. At this point in time, the battery door is still locked so that it is impossible to open it completely. Then, the battery door is unlocked by pressing the button by a tool., e.g. a small screwdriver. Afterwards, the battery door can be completely opened. Since the button is disposed at the long side of the battery locking mechanism the gap between the battery door and the housing can be very small.

As an example U.S. Pat. No. 5,386,476 describes a hearing aid with a locking device configured to avoid inadvertent opening of the battery compartment. The locking device includes a displaceable pin, which can be maneuvered through an opening in the battery chamber by means of a pointed or thin object, e.g. a mandrel-shaped tool or the like. The pin is slidable and in one position it blocks the opening movement of the battery door and in a second position it is in-active and the door can be opened.

As another example, US 2007/0081684 A1 discloses a hearing aid with a casing and a battery door disposed in the casing. The device includes an arrest pin to block the movement of a latch when a child-resistant battery enclosure is desired.

However, the aforementioned battery door locking mechanisms have the following disadvantages:

First, a small pointed tool, e.g. a small screwdriver, is needed, at least for unlocking the respective battery door locking mechanism, which implies the risk of the tool's user to get injured by the tool. Besides, the hearing aid might easily be damaged by such a tool. Furthermore, handling such a small pointed tool might be difficult for an aged person having constrained sensory and motor capabilities.

In addition, dirt may settle in the above holes provided in the housings of some conventional hearing aids. Regarding the above alternative battery door locking mechanisms which are accessible via the battery compartment dirt adhered to the tool might get into the respective hearing aid battery compartment.

A similar problem applies to the housing of a hearing aid which normally includes two portions—a base portion and a cover portion. In the case that the hearing aid needs to be repaired or maintained the inside of the device needs to be made accessible. This is usually done by removing a couple of screws from the housing whereupon the cover portion can be taken from the rest of the hearing aid. However, the screw holes of the housing or their caps bear the risk to get polluted which is higher than the accordant risk of a smooth surface.

Besides, there is a risk that an unauthorized person opens the housing by removing the screws.

Various embodiments provide a hearing aid including a housing, a battery door configured to receive a battery, and a battery door locking mechanism, wherein the battery door locking mechanism includes a magnetic element which is configured to magnetically lock or unlock the battery door.

Furthermore, various embodiments provide a hearing aid which has a housing including a first housing portion and a second housing portion and a housing locking mechanism, wherein the housing locking mechanism includes a magnetic element configured to magnetically lock the first housing portion with the second housing portion or to unlock the first housing portion from the second housing portion.

In addition, the various embodiments provide a method for operating the battery door locking mechanism of a hearing aid, wherein the method may include bringing an external actuator having a magnetic means close to the hearing aid and magnetically actuating a battery door locking mechanism of the hearing aid, thereby locking or unlocking the battery door, wherein the battery locking mechanism includes a magnetic element configured to magnetically lock or unlock the battery door.

In various embodiments, a magnetic actuation of the battery door locking mechanism is provided which makes a small pointed tool for actuating the mechanism needless.

In various embodiments, the magnetic actuation of the battery door locking mechanism may allow an easy operation of the battery door locking mechanism by an external actuator wherein the external actuator does not need to be positioned such precisely as the above described tool in order to operate the locking mechanism.

In various embodiments, the magnetic actuation of the housing locking mechanism makes screws for fixing the cover portion on the base portion of the hearing aid needless.

In one embodiment, the magnetic element may include or be e.g. a ferromagnet, an electromagnet, a permanent magnet, and/or an electro-permanent magnet.

The magnetic element may further include two parts wherein a first part of the magnetic element is disposed at (e.g. mounted on) the housing and a second part of the magnetic element is disposed at (e.g. mounted on) the battery door, wherein the first part and the second part of the magnetic element are disposed relative to each other such that they lock the battery door to the housing when the battery door is closed.

In one embodiment, the first part of the magnetic element may be an electromagnet or an electro-permanent magnet.

According to another embodiment, the second part of the magnetic element may be a ferromagnet or a permanent magnet.

The hearing aid may further include an integrated circuit configured to control a voltage applied to the magnetic element.

Furthermore, the hearing aid may include a magnetic switch configured to switch on or off a voltage applied to the magnetic element.

In addition, the hearing aid may include a hinge connecting the battery door and the housing.

According to a further embodiment, the hearing aid may include a spring configured to open the battery door when the battery door is unlocked.

Moreover, the housing locking mechanism may include a lever configured to secure the first housing portion at the second housing portion when the first housing portion is locked with the second housing portion.

Furthermore, a hearing aid arrangement may include a hearing aid and an external actuator having a magnetic means, wherein the battery door locking mechanism of the hearing aid may be configured to be operated by the magnetic means of the external actuator.

Furthermore, a hearing aid arrangement may include a hearing aid and an external actuator having a magnetic device, wherein the housing locking mechanism of the hearing aid is configured to be operated by the magnetic device of the external actuator.

In one embodiment, the method for operating the battery door locking mechanism of a hearing aid may include applying a voltage to the magnetic element of the battery door locking mechanism.

The voltage application to the magnetic element can be triggered by a magnetic switch of the hearing aid wherein the magnetic switch is operated by the magnetic means of the external actuator.

In the drawings, like reference signs generally refer to the same parts throughout the different views. The drawings are not necessarily to scale, emphasis instead being placed upon illustrating the principles of various embodiments. In the following description, various embodiments are described with reference to the following drawings, in which:

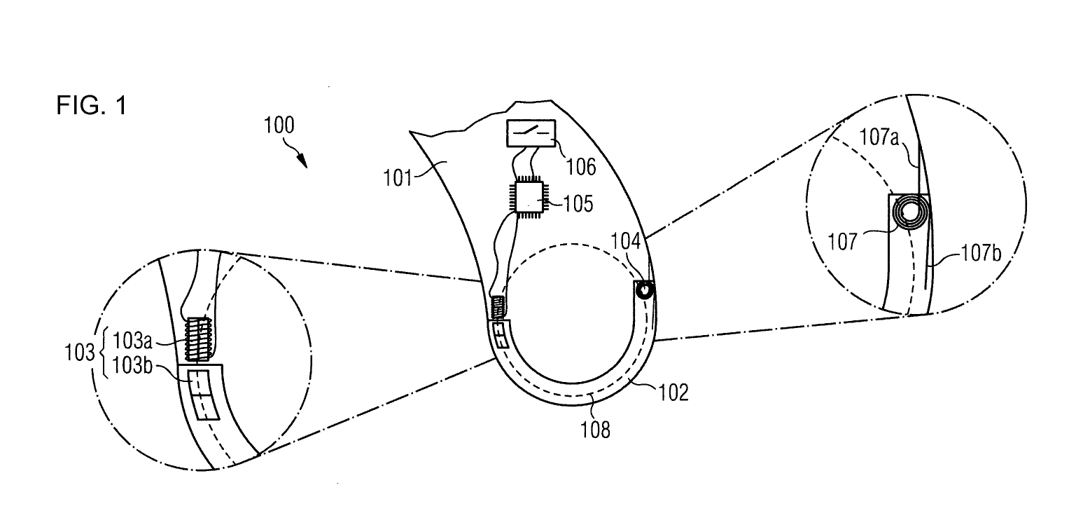

FIG. 1 illustrates a cross-sectional view of a portion of a hearing aid according to an embodiment;

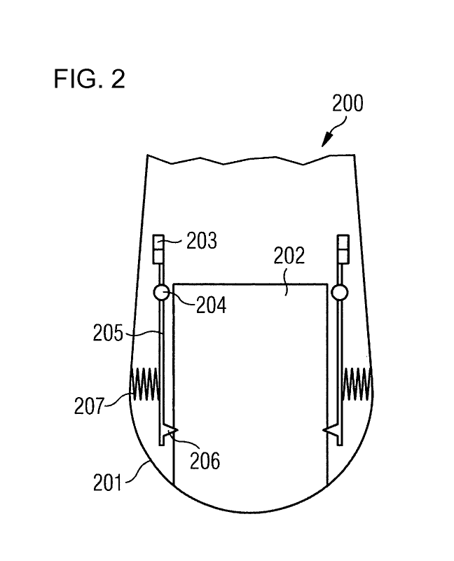

FIG. 2 illustrates a cross-sectional view of a portion of a hearing aid according to an embodiment;

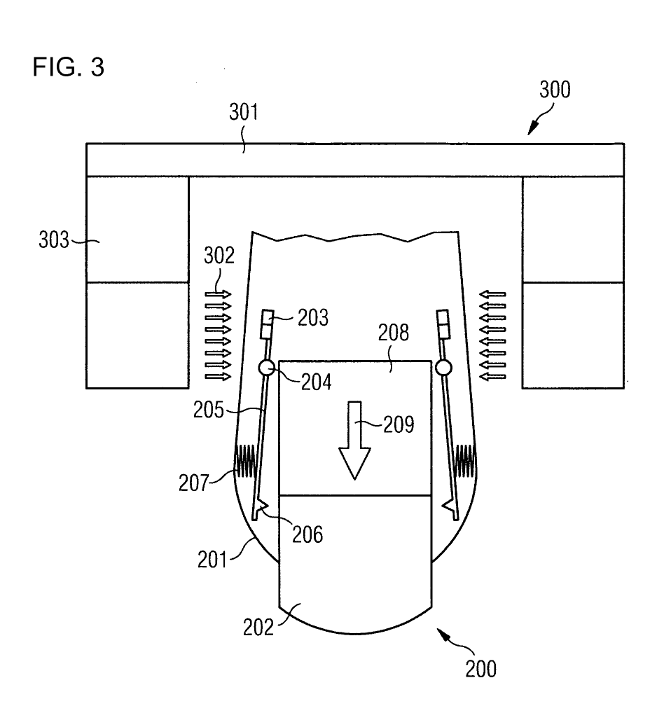

FIG. 3 illustrates a cross-sectional view of the portion of the hearing aid of FIG. 2, together with a cross-sectional view of an external actuator according to an embodiment; and

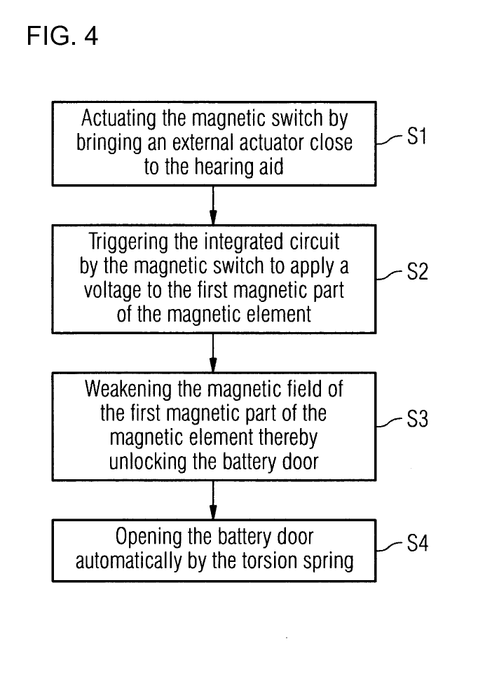

FIG. 4 illustrates a flow diagram of a method for operating the battery door locking mechanism of the hearing aid of FIG. 1.

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

FIG. 1 illustrates a cross-sectional view of a portion of a hearing aid (100) according to an embodiment.

The hearing aid 100 illustrated in FIG. 1 is a BTE (Behind The Ear) hearing aid. However, another type of a hearing aid, e.g. an ITE (In The Ear) hearing aid, an OTE (Over The Ear) hearing aid, an ITC (In The Canal) hearing aid, a MIC (Mini Canal) hearing aid, a CIC (Completely in the Canal) hearing aid, a RITE (Receiver in The Ear) hearing aid, or an eyeglass hearing aid may also be provided in alternative embodiments.

The hearing aid 100 may include a housing 101, wherein only a portion of the housing 101 is shown in FIG. 1. Furthermore, the hearing aid 100 may include a battery door 102 which is shown in a closed-state in FIG. 1. The battery door 102 may be configured to receive a battery 108 which is placed in a battery compartment (not shown) of the housing 101. The battery 108 may be a button battery cell or another suitable battery.

The hearing aid 100 may further include a hinge 104 connecting the battery door 102 and the housing 101. The hinge allows the battery door 102 to rotate or pivot relative to the housing 101 in a limited angle wherein the rotation axis (pivot axis) passes through the housing 101 and the battery door 102.

Moreover, the hearing aid 100 according to FIG. 1 may include a torsion spring 107 configured to open the battery door 102 when it is unlocked. The torsion spring 107 has two arms 107a, 107b wherein one of the arms (e.g. a first arm) 107a may be pressed against the inside of the housing 101 by means of the spring force of the torsion spring 107 and the other arm (e.g. a second arm) 107b may be pressed against the inside of the battery door 102 by means of the spring force of the torsion spring 107. In one or more embodiments, the axis of the torsion spring 107 coincides with the rotation axis of the hinge 104.

Moreover, the hearing aid 100 may include a battery door locking mechanism with the following components:

The battery door locking mechanism may have a magnetic element 103 having two magnetic parts 103a, 103b, wherein the first magnetic part 103a may be disposed at (e.g. mounted on) the housing 101 and the second magnetic part 103b may be disposed at (e.g. mounted on) the battery door 102. Both magnetic parts 103a, 103b may be arranged relative to each other such that they can lock (or selectively and controlledly unlock) the battery door 102. Therefore, the magnetic parts 103a, 103b may be positioned in such a distance from each other and in such an orientation to each other that a magnetic field emitted by one of the magnetic parts 103a penetrates the other magnetic part 103b when the battery door 102 is closed such that the magnetic parts 103a, 103b attract each other. The attractive force generated by the magnetic field has such a magnitude that the battery door 102 remains securely closed when the hearing aid 100 is worn by a user, even if the hearing aid 100 is shaken.

In the embodiment shown in FIG. 1, the first magnetic part 103a of the magnetic element 103 is an electro-permanent magnet which may include a permanent magnet and an induction coil wrapped around the permanent magnet. Thus, the magnetic field of the magnetic element 103 can be influenced by applying a voltage to the induction coil. The second magnetic part 103b of the magnetic element 103 may be a ferromagnet. In an alternative embodiment, the magnetic element 103 may have two parts 103a, 103b, wherein a first part 103a of the two parts is a magnetic part 103a, and a second part 103b of the two parts is an iron part 103b. In other words, magnetic and iron parts may also be provided to cooperate as the magnetic element 103 to form the battery door locking mechanism in an alternative embodiment.

In an alternative embodiment, the first magnetic part 103a of the magnetic element 103 may be an electromagnet and the second magnetic part 103b of the magnetic element 103 may be a permanent magnet. Other combinations of the types of magnets or of other types of magnets of the magnetic parts 103a, 103b are also possible; however, in each case one of the magnetic parts 103a, 103b of the magnetic element 103 may be able to emit a changeable magnetic field.

The battery door locking mechanism may include an integrated circuit 105 configured to apply a voltage to the first magnetic part 103a of the magnetic element 103. Therefore, the integrated circuit 105 may be electrically connected with the magnetic element 103 and may be configured to switch the voltage on or off. The integrated circuit 105 can e.g. be dedicated for the above purpose only or for other purposes in addition, e.g. for processing electrical signals. Furthermore, the integrated circuit 105 may be supplied by the battery voltage.

Furthermore, the battery door locking mechanism may include a magnetic switch 106 configured to trigger the voltage application to the first magnetic part 103a by the integrated circuit 105. Therefore, the magnetic switch 106 is electrically connected to the integrated circuit 105. In one or more embodiments, a Reed-relay may be used as the magnetic switch 106. However, another type of a magnetic switch may also be used in an alternative embodiment, e.g. a Hall-switch.

In an alternative embodiment, the magnetic switch may be directly connected with the magnetic element, without an integrated circuit connected therebetween.

In the following, a method for operating the battery door locking mechanism of an embodiment will be described with reference to FIG. 1 and FIG. 4.

The magnetic switch 106 may be actuated by bringing an external actuator (not shown) close to the hearing aid 100 such that the magnetic field of the external actuator actuates the magnetic switch 106 (method step S1). In various embodiments, the external actuator may include a magnetic device. In various embodiments, the magnetic device may be a permanent magnet. However, the external actuator may also include a magnetic device which is an electromagnet or an electro-permanent magnet.

The magnetic switch in turn may trigger the integrated circuit 105 to apply a voltage to the first magnetic part 103a of the magnetic element 103 (method step S2). In an embodiment, the voltage may be applied to the induction coil of the electro-permanent magnet representing the first magnetic part 103a.

Thus, the magnetic field of the first magnetic part 103a may be weakened. As a result, the attractive force between the first magnetic part 103a and the second magnetic part 103b is also weakened such that the battery door 102 is unlocked (method step S3).

Then, the battery door 102 is opened automatically by the torsion spring 107 (method step S4).

The direction of the voltage applied to the first magnetic part 103a may be such that the magnetic field of the first magnetic part 103a may be weakened by the voltage. It is to be noted that the opposite voltage direction may strengthen the magnetic field of the first magnetic part 103a.

The magnitude of the voltage applied to the first magnetic part 103 a may be selected such that by applying the voltage the attractive force between the first magnetic part 103a and the second magnetic part 103b becomes substantially smaller than the spring force of the torsion spring 107. Thus, illustratively, the voltage applied to the first magnetic part 103a may be dimensioned such that the battery door will securely open, even if gravitation and friction counteract the spring force. On the other hand, the magnitude of the voltage applied to the first magnetic part 103a may be restricted in order to save battery power.

In an embodiment, a defined magnitude of the voltage may be stored as a digital value in a memory of the integrated circuit 105 or in a separate memory of the hearing aid 100.

Moreover, the duration of the voltage application to the first magnetic part 103a may be such that the battery door 102 is securely opened. By way of example, at the point in time when the voltage application is completed (the voltage is switched off by the integrated circuit 105), the distance between the first magnetic part 103a and the second magnetic part 103b should be large enough to prevent closing the battery door 102 again. On the other hand, the duration of the voltage application to the first magnetic part 103a may be restricted in order to save battery power. Thus, the voltage may be applied as a voltage pulse of a limited duration. In various embodiments, defining the optimum voltage pulse length (or voltage pulse duration) may involve considering the mass of the battery door 102 and the friction between the battery door 102, the hinge 104 and the housing 101.

In one or more embodiments, a constant voltage pulse length (or voltage pulse duration) of the voltage applied to the first magnetic part 103a may be used for each actuation of the battery door locking mechanism. By way of example, the voltage pulse length (or voltage pulse duration) may be independent from the duration of the actuation of the magnetic switch 106. Therefore, a defined voltage pulse length (or voltage pulse duration) can be stored as a digital value in a memory of the integrated circuit 106 or in a separate memory of the hearing aid 100.

The battery door 102 may also be opened manually in accordance with an embodiment, e.g. if the external actuator is not available or if the battery 108 is down. Therefore, the battery door 102 may be equipped with a special grip, e.g. with a nail grip.

For locking the battery door 102, the external actuator may be placed relative to the hearing aid 100 such that the external actuator is unable to actuate the magnetic switch 106. By way of example, the external actuator may be placed in a sufficient distance from the hearing aid 100. Consequently, the integrated circuit 105 will in this case not apply a sufficient voltage to the first magnetic part 103a of the magnetic element 103. Next, the battery door 102 may be manually moved into its closed-position. Then, the battery door 102 may be held in the closed-position by the first magnetic part 103a and the second magnetic part 103b attracting each other.

FIG. 2 illustrates a cross-sectional view of a portion of a hearing aid 200 according to an embodiment.

The hearing aid 200 illustrated in FIG. 2 is a BTE (Behind The Ear) hearing aid 200. However, another type of a hearing aid, e.g. an ITE (In The Ear) hearing aid, an OTE (Over The Ear) hearing aid, an ITC (In The Canal) hearing aid, a MIC (Mini Canal) hearing aid, a CIC (Completely in the Canal) hearing aid, a RITE (Receiver in The Ear) hearing aid, or an eyeglass hearing aid may also be provided in an alternative embodiment.

The hearing aid 200 may include a housing 201, wherein only a portion of the housing 101 is shown in FIG. 2. Furthermore, the hearing aid 200 may include a battery door 202 shown in a closed-state. The battery door 202 may be configured to receive a battery (not shown) which is placed in a battery compartment (not shown) behind the battery door 202. The battery may be a button battery cell or another suitable battery.

Moreover, the hearing aid 200 may include a battery door locking mechanism. The battery locking mechanism may include or consist of two portions wherein a first portion may be disposed left to the battery door 202 and the other portion may be disposed right to the battery door 202. Each of these portions may include or consist of one or more of the following components:

Each portion of the battery door locking mechanism may have a locking lever 205 configured to secure the battery door 202 in a locked-state. Therefore, the locking lever 205 may have a stud 206 disposed at one of its arms. In the closed-state of the battery door 202, the stud 206 may engage with a notch embedded in one side of the battery door 202. In this way, the locking lever 205 may prevent the battery door 202 from an undesired opening.

Furthermore, each portion of the battery door locking mechanism may have a hinge 204 connecting the lever 205 with the housing 201. The hinge 204 may allow the lever 205 to rotate relative to the housing 201 in a limited angle.

Moreover, each portion of the battery door locking mechanism may have a compression spring 207 connected between the inside of the housing 201 and the arm of the locking lever 205 including the stud 206. The compression spring 207, may be configured to push the locking lever 205 such that the stud 206 remains engaged with the notch in the locked-state of the battery door 202. Since the stud 206 holds the battery door 202, an undesired opening of the battery door 202 may be prevented. The spring force of the compression spring 207 may be dimensioned to have such a magnitude that the stud 206 securely remains in the notch, even if the hearing aid 200 is shaken by a user wearing the hearing aid 200.

Furthermore, each portion of the battery door locking mechanism may have a magnetic element 203 disposed at the arm of the locking lever 205 opposite to the stud 206. In various embodiments, the magnetic element 203 may include a permanent magnet. Alternatively, the magnetic element 203 may also include an electromagnet or an electro-permanent magnet.

The hearing aids according to various embodiments may provide the effect that no small pointed tool, e.g. no screwdriver, is needed for locking or unlocking the battery doors. Thus, the user can not get injured and the hearing aids can not be damaged by such a tool.

Further, handling the external actuator including a magnetic device may be much easier than handling a small tool for actuating the battery door locking mechanisms, for example for an aged person having constrained sensory and motor capabilities.

Moreover, the hearing aids according to various embodiments do not need to have any holes for locking or unlocking the battery doors in its housings. Thus, the adherence of dirt at the hearing aids in such holes may be prevented. There may also not be a risk that dirt adhered to tools for actuating the battery door locking mechanisms gets into the battery compartments.

In the following, a method for operating the battery locking mechanism of an embodiment will be described with reference to FIG. 3.

FIG. 3 illustrates a cross-sectional view of the portion of the hearing aid 200 of FIG. 2, together with a cross-sectional view of an external actuator 300 according to an embodiment.

The external actuator 300 may include a mounting plate 301 and two magnetic devices 303 disposed at opposite ends of the mounting plate 301, wherein each of the magnetic devices 303 may include a permanent magnet. However, in various embodiments, the one or more magnetic devices 303 may also include one or more electromagnets or one or more electro-permanent magnets.

The one or more magnetic devices 303 may be oriented in such a way that a repulsive magnetic force 302 acts between each of them and an adjacent magnetic element 203 if the external actuator 300 is positioned relative to the hearing aid 200 in order to open the battery door, as described below.

For opening the battery door 202 the hearing aid 200 may be positioned relative to the external actuator 300 in such a way that each of the magnetic elements 203 may be placed adjacent to one of the magnetic devices 303. Therefore, the portion of the hearing aid 200 including the magnetic elements 203 is placed between the magnetic devices 303, wherein each of the magnetic elements 203 may face one of the magnetic devices 303 of the external actuator 300.

Consequently, the magnetic field of each of the magnetic devices 303 may penetrate one of the magnetic elements 203, whereby a repulsive magnetic force 302 may act between the magnetic devices 303 and the magnetic elements 203. As a result, the magnetic element 203 may be pushed away from the adjacent magnetic device 303 which may cause a rotation of the related locking lever 205.

In this way, the studs 206 may be removed from the notches of the battery door 202 by means of the rotating locking levers 205. It is to be noted that the compression springs 207 are also compressed. Thus, the battery door 202 may be released from the studs 206, that is, the battery door 202 may be unlocked.

Now, the battery door 202 may be opened manually by moving the battery door 202 in the opening direction 209. As a result, the battery compartment 208 may become accessible.

For closing the battery door 202, the external actuator 300 may be placed relative to the hearing aid 200 such that the external actuator 300 is unable to unlock the battery door 202. By way of example, the external actuator 300 may be placed in a sufficient distance from the hearing aid 200. Next, the battery door 202 may be manually moved into its closed-position as shown in FIG. 2. Then, the battery door 202 may be held in the closed-position by means of the studs 206 of the locking levers 205. In more detail, the compression springs 207 may push the arms of the locking levers 205 including the studs 206 against the sides of the battery door 202, whereby the studs 206 may remain engaged with the notches of the battery door 202.

According to another embodiment, a hearing aid may have a housing including a first housing portion and a second housing portion. The first housing portion may be the base portion, and the second housing portion may be the cover portion of the housing. Furthermore, the hearing aid may include a housing locking mechanism.

The housing locking mechanism may include or consist of the following components:

The housing locking mechanism may have a locking lever configured to secure the second housing portion on the first housing portion. Therefore, the locking lever may have a stud disposed at one of its arms. In the closed-state of the housing the stud engages with a protrusion at the inside of the second housing portion. In this way, the locking lever may prevent the second housing portion from being taken from the first housing portion.

Furthermore, the housing locking mechanism may have a hinge connecting the lever with the first housing portion. The hinge may allow the lever to rotate relative to the first housing portion in a limited angle.

Moreover, the housing locking mechanism may have a compression spring connected between the inside of the first housing portion and the locking lever. The compression spring may be configured to push the arm of the locking lever including the stud such that the stud may remain engaged with the protrusion in the locked-state of the housing. Since the stud holds the second housing portion on the first housing portion an undesired opening of the housing may be prevented. The spring force of the compression spring may have such a magnitude that the stud may securely remain engaged with the protrusion, even if the hearing aid is shaken by a user wearing the hearing aid.

Furthermore, the housing locking mechanism may have a magnetic element disposed at the opposite arm of the locking lever. In various embodiments, the magnetic element may include a permanent magnet. However, the magnetic element may also include an electromagnet or an electro-permanent magnet.

The housing may be unlocked by an external actuator similar to the external actuator 300 of the second embodiment shown in FIG. 3.

An effect of the hearing aid according to an embodiment may be that the housing of the hearing aid does not need any screw holes for locking the second housing portion to the first housing portion. Thus, the risk for the hearing aid to get polluted may be reduced.

Furthermore, the risk that an unauthorized person opens the housing may be reduced, since such a person may normally not own the external actuator for operating the housing locking mechanism.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-17. (canceled)

18. A hearing aid, comprising:
a housing;
a battery door associated with said housing and configured to receive a battery; and
a battery door locking mechanism;
said battery door locking mechanism including a magnetic element configured to magnetically lock or unlock said battery door.

19. The hearing aid according to claim 18, wherein said magnetic element includes a magnet selected from a group of magnets consisting of:
a ferromagnet,
an electromagnet,
a permanent magnet, and
an electro-permanent magnet.

20. The hearing aid according to claim 18, wherein:
said magnetic element includes first and second parts;
said first part of said magnetic element being disposed at said housing and said second part of said magnetic element being disposed at said battery door;
said first and second parts of said magnetic element being disposed relative to each other such that they lock said battery door to said housing when said battery door is closed.

21. The hearing aid according to claim 20, wherein said first part of said magnetic element is an electromagnet or an electro-permanent magnet.

22. The hearing aid according to claim 20, wherein said second part of said magnetic element is a ferromagnet or a permanent magnet.

23. The hearing aid according to claim 21, which further comprises an integrated circuit configured to control a voltage applied to said magnetic element.

24. The hearing aid according to claim 21, which further comprises a magnetic switch configured to switch on or off a voltage applied to said magnetic element.

25. The hearing aid according to claim 18, which further comprises a hinge interconnecting said battery door and said housing.

26. The hearing aid according to claim 18, which further comprises a spring configured to open said battery door when said battery door is unlocked.

27. A hearing aid, comprising:
a housing including a first housing portion and a second housing portion; and
a housing locking mechanism;
said housing locking mechanism including a magnetic element configured to magnetically lock said first housing portion with said second housing portion or to unlock said first housing portion from said second housing portion.

28. The hearing aid according to claim 27, wherein said magnetic element includes a magnet selected from a group of magnets consisting of:
a ferromagnet,
an electromagnet,
a permanent magnet, and
an electro-permanent magnet.

29. The hearing aid according to claim 27, wherein said housing locking mechanism further includes a lever configured to secure said first housing portion at said second housing portion when said first housing portion is locked with said second housing portion.

30. A hearing aid configuration, comprising:
a hearing aid according to claim 18; and
an external actuator including a magnetic device;
said battery door locking mechanism of said hearing aid being configured to be operated by said magnetic device of said external actuator.

31. A hearing aid configuration, comprising:
a hearing aid according to claim 27; and
an external actuator including a magnetic device;
said housing locking mechanism of said hearing aid being configured to be operated by said magnetic device of said external actuator.

32. A method for operating a battery door locking mechanism of a hearing aid, the method comprising the following steps:
providing a magnetic element in the battery door locking mechanism configured to magnetically lock or unlock the battery door;
bringing an external actuator including a magnetic device close to the hearing aid; and
magnetically activating the battery door locking mechanism of the hearing aid thereby locking or unlocking the battery door.

33. The method according to claim 32, which further comprises carrying out the step of activating the battery door locking mechanism by applying a voltage to the magnetic element of the battery door locking mechanism.

34. The method according to claim 33, which further comprises triggering the voltage application to the magnetic element with a magnetic switch of the hearing aid, and operating the magnetic switch with the magnetic device of the external actuator.
